(19) United States
(12) Patent Application Publication
(10) Pub. No.: US 2006/0007675 A1
(43) Pub. Date: Jan. 12, 2006

(54) Flashlight

(76) Inventor: Jerry Song, Taipei City (TW)

Correspondence Address: Jerry Song, P.O. Box 90, Tainan City, 704, TW

(21) Appl. No.: 10/886,692

(22) Filed: Jul. 9, 2004

(51) Int. Cl. F21L 7/00

(52) U.S. Cl. 362/157

(57) ABSTRACT

A flashlight includes a tube body, a bottom base, a battery, a circuit board and an upper cover. When the battery and the circuit board is electrically connected, plural LED provided on the circuit board will emit bright light, which is simultaneously projected outward through the light-transmitting hole of the upper cover. The upper cover has its upper end connected with an elongate transparent bar, and the circuit board has its topside assembled with a light-refracting shade able to focus the light source emitted by the LED and reflect it on the elongate transparent bar. The circuit board controls the light emitting diodes to emit changeable different-colored light which is synchronously reflected outward by the elongate transparent bar. The flashlight can be repeatedly used unlimitedly, contributing to environmental protection.

### BACKGROUND OF THE INVENTION

1. Field of the Invention

This invention relates to a flashlight, particularly to one composed of a tube body, a bottom base, a battery, a circuit board and an upper cover. When the battery and the circuit board are electrically connected, plural LED (light emitting diodes) on the circuit board will emit bright light, which is synchronously projected outward for lighting through the light-transmitting hole of the upper cover. The upper cover has its upper end connected with an elongate transparent bar, and the circuit board has its topside assembled with a light-refracting shade so that the light source emitted by the LED can be focused by the light refracting shade and reflected on the elongate transparent bar. Thus, the circuit board is able to control the light emitting diode to emit changeable different-colored light, and the elongate transparent bar able to reflect this changeable different-colored light, which is more brilliant and changeable than that given out by common fluorescent bars. In addition, the flashlight of this invention can be repeatedly used unlimitedly, contributing to environmental protection.

2. Description of the Prior Art

Generally, during singing performance or recreational activities at night, fluorescent bars are indispensable for producing a romantic or joyful atmosphere. However, a conventional fluorescent bar has its interior filled with more than two kinds of fluorescent liquids wrapped up by a soft sack. In using, the fluorescent bar is bent and compressed to break the soft sack to let the different fluorescent liquids flow out and mixed with each other to produce chemical reaction and give out fluorescent light, but the light produced by the fluorescent liquids will fade after employed for a period of time, and after losing fluorescent effect the fluorescent bar will be thrown away. The discarded fluorescent bars still have poisonous chemicals still left inside so they will cause serious pollution and damage to the environment. In addition, the conventional fluorescent bar can only give out single-colored light; therefore, different-colored fluorescent bars have to be purchased in order to produce different-colored light, but this light is still quite monotonous and unchangeable.

### SUMMARY OF THE INVENTION

The objective of the invention is to offer a flashlight able to be repeatedly used unlimitedly and also able to be used as fluorescent bars for giving out changeable different-colored light.

The flashlight in the present invention includes a tube body, a bottom base, a battery, a circuit board and an upper cover. The tube body has its interior formed with a chamber, and its upper and lower end respectively provided with male threads. The bottom base to be threadably combined with the lower end of the tube body has its interior formed with a chamber provided therein with an electric conductor and having it inner wall formed with female threads. The battery is received in the chamber of the tube body. The circuit board is fitted at the upper end of the tube body, having at least one LED installed thereon. The upper cover to be threadably combined with the upper end of the tube body has its interior formed with a chamber provided therein with an annular stop edge and having its lower inner wall formed with female threads. The upper cover further has its topside bored with a light-transmitting hole communicating with the chamber.

### BRIEF DESCRIPTION OF DRAWINGS

This invention will be better understood by referring to the accompanying drawings, wherein:

FIG. 1 is an exploded perspective view of a first preferred embodiment of a flashlight in the present invention;

FIG. 2 is a side cross-sectional view of the first preferred embodiment of the flashlight in the present invention;

FIG. 3 is an exploded perspective view of a second preferred embodiment of a flashlight in the present invention;

FIG. 4 is a side cross-sectional view of the second preferred embodiment of the flashlight in the present invention;

FIG. 5 is a perspective view of the second preferred embodiment of the flashlight in the present invention;

FIG. 6 is an exploded perspective view of a third preferred embodiment of a flashlight in the present invention; and,

FIG. 7 is a perspective view of the third preferred embodiment of the flashlight in the present invention.

### DETAILED DESCRIPTION OF THE PREFERRED EMBODIMENT

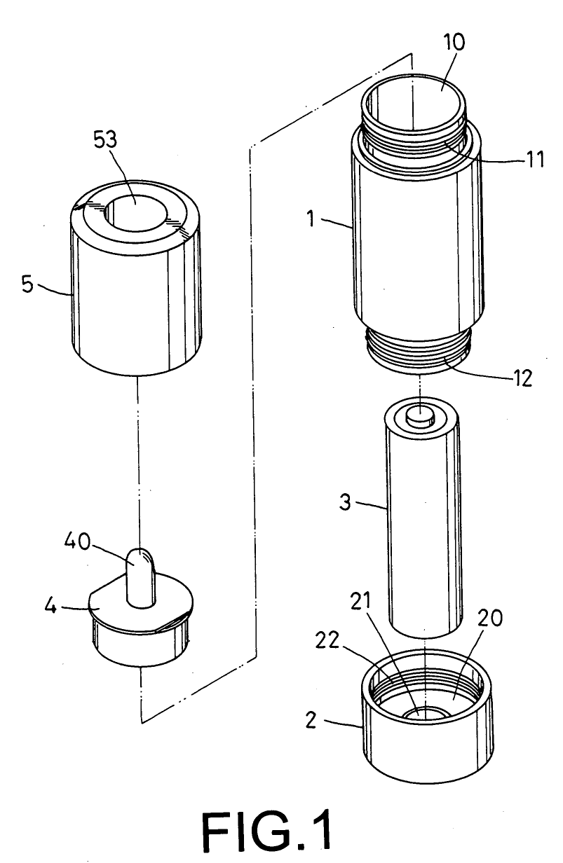

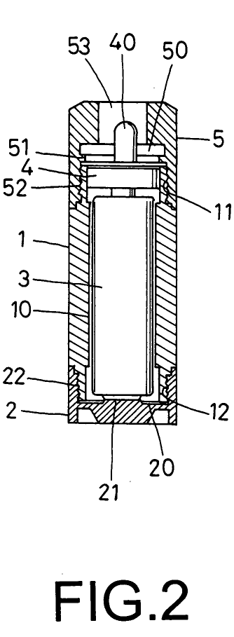

A first preferred embodiment of a flashlight in the present invention, as shown in FIGS. 1 and 2, includes a tube body 1, a bottom base 2, a battery 3, a circuit board 4 and an upper cover 5 combined together.

The tube body 1 is formed with a chamber 10 in the interior, and has its upper and lower end respectively provided with male threads 11, 12.

The bottom base 2 to be threadably combined with the lower end of the tube body 1 has its interior formed with a chamber 20 provided therein with an electric conductor 21 and having its inner wall provided with female threads 22.

The battery 3 is received in the chamber 10 of the tube body 1.

The circuit board 4 is fitted at the upper end of the tube body 1, having an LED provided thereon.

The upper cover 5 to be threadably assembled on the tube body 1 has its interior formed with a chamber 50 and its topside formed with a light-transmitting hole 53 communicating with the chamber 50. The chamber 50 of the upper cover 5 is provided with an annular stop edge 51 in the interior and has its lower inner wall provided with female threads 52.

In assembling, as shown in FIGS. 1 and 2, firstly, the bottom base 2 is threadably assembled with the lower end of the tube body 1 by having its female threads 22 engaging the male threads 12 of the tube body 1. Next, the battery 3 is received in the chamber 10 of the tube body 1, letting the bottom of the battery 3 contact with the electric conductor 21 inside the bottom base 2. Subsequently, the circuit board 4 is fitted at the upper end of the tube body 1, and the upper cover 5 is threadably assembled with the upper end of the tube body 1 by having its female threads 52 engaging the male threads 11 of the tube body 1, letting the upper edge of the circuit board 4 push against the lower side of the stop edge 51 inside the upper cover 5, thus finishing assembly of the flashlight with ease and with quickness.

In using, simply have the upper cover 5 and the tube body 1 and the bottom base 2 screwed tight with one another to make the circuit board 4 and the battery 3 electrically connected to enable the light emitting diode 40 on the circuit board 4 to emit bright light, which is synchronously projected outward through the light-transmitting hole 53 of the upper cover 5 to form a light source for lighting.

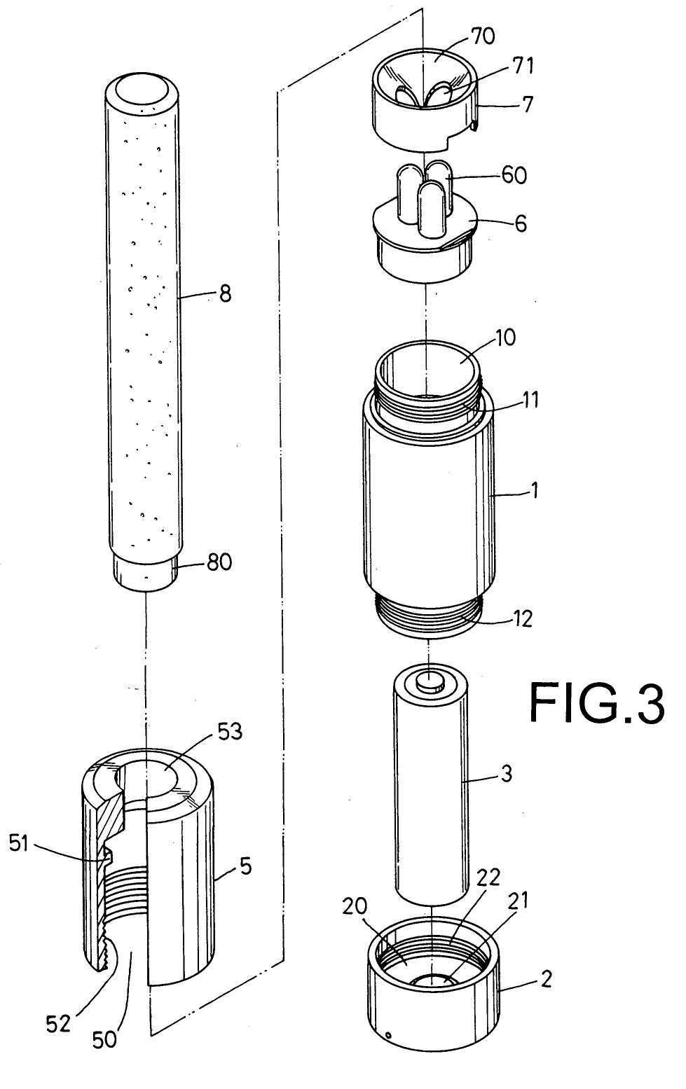

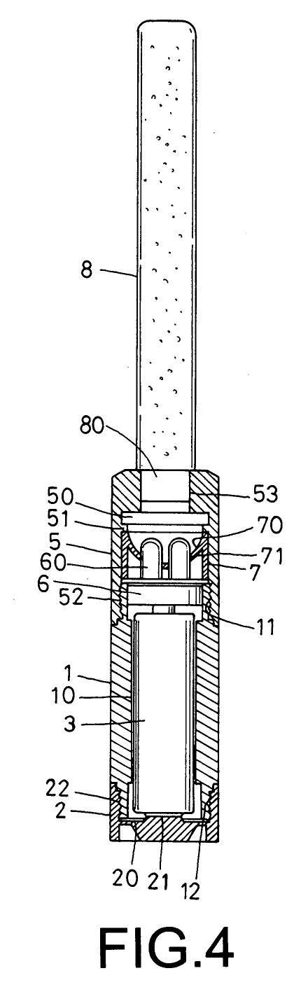

A second preferred embodiment of a flashlight in the present invention, as shown in FIGS. 3 and 4, includes a tube body 1, a bottom base 2, a battery 3, a circuit board 6, a light-refracting shade 7, an upper cover 5 and an elongate transparent bar 8 combined together.

The tube body 1 has its interior formed with a chamber 10, and its upper and lower end respectively provided with male threads 11, 12.

The bottom base 2 to be threadably combined with the lower end of the tube body 1 has its interior formed with a chamber 20 provided therein with an electric conductor 21 and having its inner wall provided with female threads 22.

The battery 3 is received in the chamber 10 of the tube body 1.

The circuit board 6 to be fitted at the upper end of the tube body 1 is provided thereon with plural LED 60, which emit different-colored light.

The light-refracting shade 7 to be assembled on the circuit board 6 has its topside formed with a recessed arc-shaped light-refracting surface 70 with plural insert holes 71.

The upper cover 5 to be threadably combined with the upper end of the tube body 1 has its interior formed with a chamber 50 provided therein with an annular stop edge 51 and having its lower inner wall provided with female threads 52. The upper cover 5 further has its topside bored with a light-transmitting hole 53 communicating with the chamber 50.

The elongate transparent bar 8 is to be fitted at the upper end of the upper cover 5, having its lower end formed with a connecting member 80.

In assembling, as shown in FIGS. 3, 4 and 5, firstly, the bottom base 2 is threadably combined with the lower end of the tube body by having its female threads 22 screwed with the male threads 12 of the tube body 1. Next, the battery 3 is received in the chamber 10 of the tube body 1, letting the bottom of the battery 3 contact with the electric conductor 21 inside the bottom base 2. Then, the circuit board 6 is assembled under the light-refracting shade 7, letting the plural LED 60 on the circuit board 6 respectively inserted upward through the insert holes 71 of the light-refracting shade 7. Subsequently, the light-refracting shade 7 together with the circuit board 6 are received in the chamber 50 of the upper cover 5, letting the upper edge of the light-refracting shade 7 push against the lower side of the annular stop edge 51 inside the upper cover 5. Afterward, the upper cover 5 is threadably assembled with the upper end of the tube body 1 by having its female threads 52 screwed with the male threads 11 of the tube body 1. Lastly, the elongate transparent bar 8 has its lower connecting member 80 inserted in the light-transmitting hole 53 of the upper cover 5 to finish assembly of the flashlight, convenient and quick in assembling.

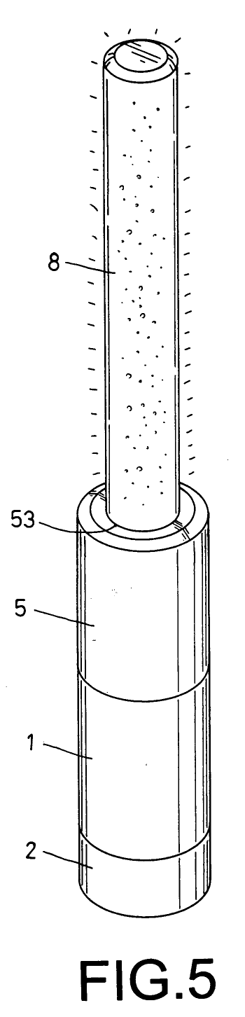

In using, simply have the upper cover 5 and the tube body 1 and the bottom base 2 screwed tight with one another to let the circuit board 6 and the battery 3 electrically connected to enable the LED 60 on the circuit board 6 to emit bright light which is synchronously focused by the light-refracting surface 70 of the light-refracting shade 7 and projected outward through the light-transmitting hole 53 of the upper cover 5 and reflected on the elongate transparent bar 8, as shown in FIG. 5. Thus, the circuit board 6 is able to control the LED 60 to emit changeable different-colored light which is simultaneously projected on the elongate transparent bar 8 to be reflected outward. During singing performance or recreational activities at night, the flashlight of this invention can serve as shining bars to emit changeable different-colored light which is more changeable and brilliant than the light given out by fluorescent bars and further it can be repeatedly employed unlimitedly.

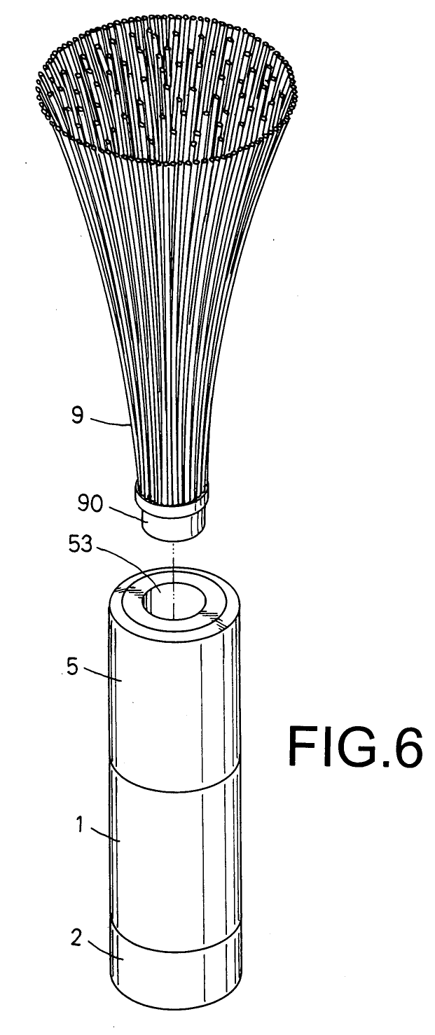

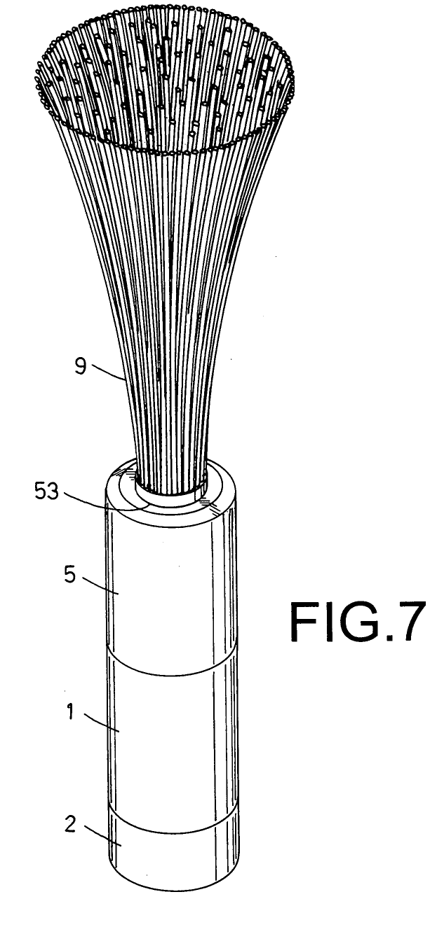

A third preferred embodiment of a flashlight in the present invention has a structure almost the same as that described in the second preferred embodiment, except that the upper cover 5 has its upper side connected with a multi-stick and bunch-like transparent member 9, as shown in FIGS. 6 and 7. The multi-stick and bunch-like transparent member 9 has its lower end formed with an insert member 90 to be inserted in the light-transmitting hole 53 of the upper cover 5. Just as described in the second preferred embodiment, the circuit board 6 controls the LED 60 to emit changeable different-colored light which is synchronously projected on the multi-stick and bunch-like transparent member 9 by the light refracting shade 7, letting the multi-stick and bunch-like transparent member 9 reflect the changeable different-colored light. In addition, the bottom base 2 of the flashlight of this invention can be placed on the top of a table and the elongate transparent bar 8 can be replaced with different-shaped transparent decorative articles, such as a couple of dancers, a couple of swans or mandarin ducks, to serve as an ornament with changeable light.

As can be understood from the above description, this invention has the following advantages.

1. The flashlight can be used as a shining bar, able to emit changeable different-colored light.

2. The flashlight can be repeatedly used unlimitedly, contributing to environmental protection.

3. The flashlight can serve as an ornament for beautifying the interior of one's home and producing a romantic atmosphere.

4. The flashlight can be employed for lighting.

While the preferred embodiments of the invention have been described above, it will be recognized and understood that various modifications may be made therein and the appended claims are intended to cover all such modifications that may fall within the spirit and scope of the invention.

What is claimed is:

1. A flashlight comprising:
a tube body formed with a chamber in the interior, said tube body having its upper and lower end respectively provided with male threads;
a bottom base threadably combined with the lower end of said tube body, said bottom base formed with a chamber in the interior, said chamber provided with an electric conductor inside, said chamber having its inner wall provided with female threads;
a battery received in said chamber of said tube body;
a circuit board fitted at the upper side of said tube body, said circuit board provided thereon with at least one light emitting diode; and,
an upper cover threadably assembled on said tube body, said upper cover formed with a chamber in the interior, said chamber having an annular stop edge provided inside, said chamber having its lower inner wall formed with female threads, said upper cover having its topside bored with a light-transmitting hole communicating with said chamber.

2. The flashlight as claimed in claim 1, wherein said circuit bored has its topside assembled thereon with a light-refracting shade having its topside formed with a recessed arc-shaped light-refracting surface with plural insert holes.

3. The flashlight as claimed in claim 1, wherein said upper cover has its upper end inserted with an elongate transparent bar.

4. The flashlight as claimed in claim 3, wherein said elongate transparent bar is a multi-stick and bunch-like transparent member.

5. The flashlight as claimed in claim 3, wherein said elongate transparent bar has its lower end formed with a connect member for inserting.
